(19) United States
(12) Patent Application Publication
(10) Pub. No.: US 2026/0148415 A1
(43) Pub. Date: May 28, 2026

(54) Learnable Feature Matching Using 3D Signals

(71) Applicant: Google LLC, Mountain View, CA (US)

(72) Inventors: Arjun Karpur, San Francisco, CA (US); Guilherme Mendeleh Perrotta, Campinas (BR); Ricardo Martin-Brualla, Seattle, WA (US); André Filgueiras de Araujo, Belo Horizonte (BR)

(21) Appl. No.: 19/150,085

(22) PCT Filed: May 9, 2023
(86) PCT No.: PCT/US2023/021513

§ 371 Date: Jul. 22, 2025

Related U.S. Application Data
(60) Provisional application No. 63/482,286, filed on Jan. 30, 2023.

(51) Int. Cl. G06T 7/73; G06V 10/774; G06V 10/776; G06V 10/82

(52) U.S. Cl. CPC G06T 7/74; G06V 10/774; G06V 10/776; G06V 10/82; G06T 2207/20081; G06T 2207/20084

(57) ABSTRACT

A method includes determining first image features of an object as represented in a first pose in a first image and second image features of the object as represented in a second pose in a second image. The method also includes determining, based on the first image, first three-dimensional (3D) coordinates representing the first image features in a 3D reference frame of the object and, based on the second image, second 3D coordinates representing the second image features in the 3D reference frame. The method additionally includes determining, using a machine learning model. (i) first 3D-augmented embeddings based on the first image features and the first 3D coordinates and (ii) second 3D-augmented embeddings based on the second image features and the second 3D coordinates. The method further includes determining correspondences between the first and second image features based on comparing the first and second 3D-augmented embeddings.

### CROSS REFERENCE TO RELATED APPLICATIONS

This application claims priority to U.S. provisional patent application No. 63/482,286, filed on Jan. 30, 2023, and titled “Learnable Feature Matching Using 3D Signals,” which is hereby incorporated by reference as if fully set forth in this description.

### BACKGROUND

Machine Learning models may be used to process various types of data, including images, audio, video, time series, text, and/or point clouds, among other possibilities. Improvements in the machine learning models may allow the models to carry out the processing of data faster and/or utilize fewer computing resources for the processing. Improvements in the machine learning models may also allow the models to generate outputs that are relatively more accurate, precise, and/or otherwise improved.

### SUMMARY

Two or more images may each represent an object in different poses. The poses may be a result of movement of the object and/or movement of a camera that captured the two or more images. As part of various image-based tasks, it may be desirable to determine a correspondence between a first set of image features of the object as depicted in a first image and a second set of image features of the object as depicted in a second image. Accurate determination of the correspondence may be facilitated by determining and utilizing three-dimensional (3D) information about the object in combination with two-dimensional (2D) information present in the images. Specifically, for each of the two or more images and based thereon, a corresponding plurality of local image features that represent 2D information may be determined and, for each respective local image feature, corresponding 3D coordinates representing the respective local image feature in a reference frame of the object may be determined. Each respective local image feature and the corresponding 3D coordinates thereof may be processed by one or more machine learning (ML) models to determine a corresponding 3D-augmented embedding that includes both 2D and 3D information about the respective local image feature. The 3D-augmented embeddings may be used to determine the correspondence between the first set of image features and the second set of image features.

In a first example embodiment, a method includes determining (i), based on a first image, a first plurality of local image features of an object as represented in a first pose in the first image and (ii), based on a second image, a second plurality of local image features of the object as represented in a second pose in the second image. The method also includes determining (i), based on the first image, a first plurality of three-dimensional (3D) coordinates representing the first plurality of local image features in a 3D reference frame of the object and (ii), based on the second image, a second plurality of 3D coordinates representing the second plurality of local image features in the 3D reference frame. The method additionally includes determining, using one or more ML models. (i) a first plurality of 3D-augmented embeddings based on the first plurality of local image features and the first plurality of 3D coordinates and (ii) a second plurality of 3D-augmented embeddings based on the second plurality of local image features and the second plurality of 3D coordinates. The method further includes determining correspondences between the first plurality of local image features and the second plurality of local image features based on comparing the first plurality of 3D-augmented embeddings and the second plurality of 3D-augmented embeddings.

In a second example embodiment, a system may include a processor and a non-transitory computer-readable medium having stored thereon instructions that, when executed by the processor, cause the processor to perform operations in accordance with the first example embodiment.

In a third example embodiment, a non-transitory computer-readable medium may have stored thereon instructions that, when executed by a computing device, cause the computing device to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a computing device, in accordance with examples described herein.

FIG. 2 illustrates a computing system, in accordance with examples described herein.

FIG. 3 illustrates a correspondence system, in accordance with examples described herein.

FIGS. 4A and 4B each illustrate an image of an object in a corresponding orientation, in accordance with examples described herein.

FIG. 5 illustrates a training system, in accordance with examples described herein.

FIG. 6 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. OVERVIEW

Determining correspondences between image features of an object across different images thereof that represent the object in different poses (i.e., positions and/or orientations) is an important computer vision task with many applications. Determination of correspondences may, for example, facilitate a determination of a 3D structure of the object, determination of camera poses associated with capturing the different images, localization of the camera relative to a map that represents a location of the object, and/or generation of additional images representing the object from additional perspectives, among other possibilities. Accordingly, determination of correspondences may be used in applications including augmented reality, virtual reality, object modeling, robotics, autonomous vehicles, and/or map-based navigation, among other possibilities.

The image features of the object, which may alternatively be referred to as local image features and/or object keypoints, may represent salient locations on and/or salient parts of the object. The local image features may be determined using a model configured to repeatably identify the same or similar local image features across the different images of the object in different poses, such that different sets of local image features corresponding to the different images may be matched to identify the correspondences. A respective local image feature may include corresponding feature position data and a corresponding feature descriptor. The corresponding feature position data may represent a 2D position of the respective local image feature within the image (e.g., using an x-coordinate and a y-coordinate) and may include a confidence value associated with (e.g., representing an accuracy of) detection of the respective local image feature. The corresponding feature descriptor may provide a latent representation (e.g., vector or matrix) of visual contents associated with the respective local image feature.

The determination of the local image features and/or the matching thereof across different images may be performed using ML models and/or traditional (non-ML-based) algorithms. However, models and/or algorithms that rely on 2D information present in the images of the object, but that do not also explicitly utilize 3D information determinable based on such images, may determine inaccurate and/or incomplete correspondences. The inaccuracy and/or incompleteness of the correspondences may be especially apparent when comparing two images that represent the object in significantly different poses (i.e., two images that differ by a wide baseline), such that relatively small portions of the object (and thus a relatively small number of local images) are co-visible in both images. Further, even when some explicit 3D information is utilized, the accuracy and/or completeness of the correspondences might not be significantly improved when the 3D information is not structured and/or represented in a format that provides meaningful additional information for the correspondence matching task.

Accordingly, a local image feature matching system and/or process may be configured to consider 3D information by determining, for each respective local image feature of a plurality of local image features identified in an image of the object, a 3D coordinate representing a 3D position of the respective local image feature in a reference frame of the object. The reference frame may be shared by a plurality of different object instances of a same class/type as the object (e.g., different shoe models/styles, where the object is a shoe), such that each object instance is represented in a same position and orientation relative to the reference frame and/or is scaled to match a predetermined size of the reference frame. Accordingly, a 3D coordinate ML model may be trained to determine the 3D coordinates for the respective local image feature based on the image of the object.

For example, the reference frame may include a normalized object coordinate space (NOCS), which may be represented as a rectangular prism (e.g., cube) of predetermined size. When the object instance is a shoe, the 3D coordinates of different shoes may be expressed with each shoe having, for example, its back bottom left portion aligned with an origin of the reference frame. The 3D coordinate ML model may thus be trained to determine the 3D coordinates for local image features of different instances of shoes.

A 3D-augmented embedding may be determined for each respective local image feature based on the feature position data, the feature descriptor, and the 3D coordinate of the respective local image feature. For example, a latent 2D position may be determined by processing the feature position data by a 2D position ML model configured to generate latent 2D positions of local image features based on the feature position data thereof. A latent 3D position may be determined by processing the 3D coordinates by a 3D position ML model configured to generate latent 3D positions of local image features based on the 3D coordinates thereof. The feature descriptor, the latent 2D position, and the latent 3D position of the respective local image feature may be combined (e.g., using addition, weighted addition, concatenation, and/or other operation) to generate the 3D-augmented embedding of the respective local image feature.

To allow for matching between a first set of local image features corresponding to a first image of the object in a first pose and a second set of local image features corresponding to a second image of the object in a second (different) pose, a corresponding 3D-augmented embedding may be determined for each respective local image feature in the first and second set of local image features. The corresponding 3D-augmented embeddings of the first set of local image features may be compared to the corresponding 3D-augmented embeddings of the second set of local image features to map (i.e., determine a correspondence of) at least a first subset of the first set of local image features to at least a second subset of the second set of local image features. Since the 3D-augmented embeddings include information about both the 2D and 3D properties of the object, the accuracy of the determined correspondence between the first subset and the second subset may be improved.

For example, at least part of the comparison may be performed by a graph neural network (GNN) configured to determine self-attention scores among the corresponding 3D-augmented embeddings of the first and second sets of local image features, and/or cross-attention scores between the corresponding 3D-augmented embeddings of the first and second sets of local image features. The self-attention scores and/or the cross-attention scores may be used to determine a corresponding match descriptor for each respective local image feature of the first and second set of local image features, and the match descriptors of the first set may be compared to the match descriptors of the second set to determine the correspondences between the local image features of the first and second sets.

### I. EXAMPLE COMPUTING DEVICES AND SYSTEMS

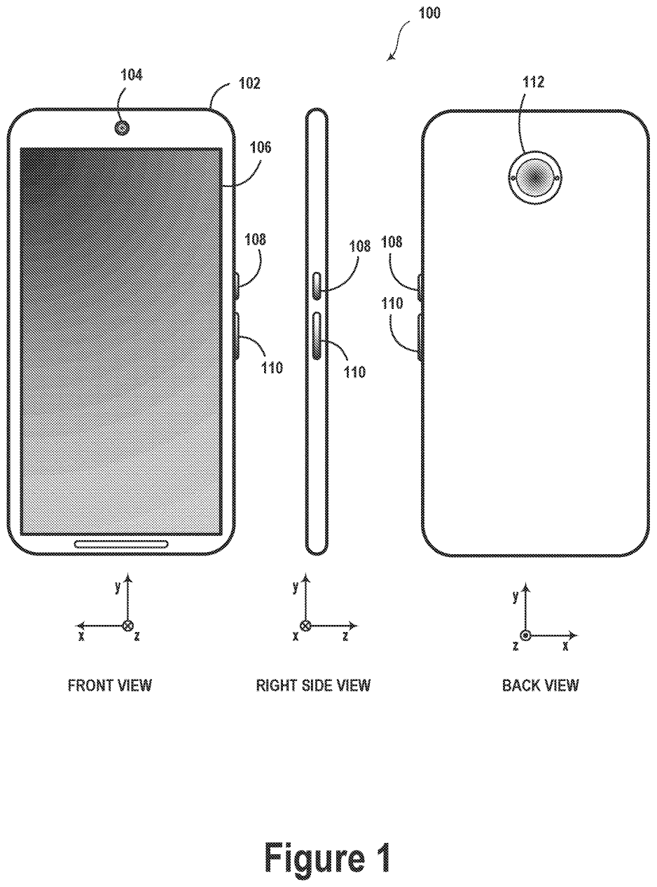

FIG. 1 illustrates an example computing device 100. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and rear-facing camera 112.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a view finder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

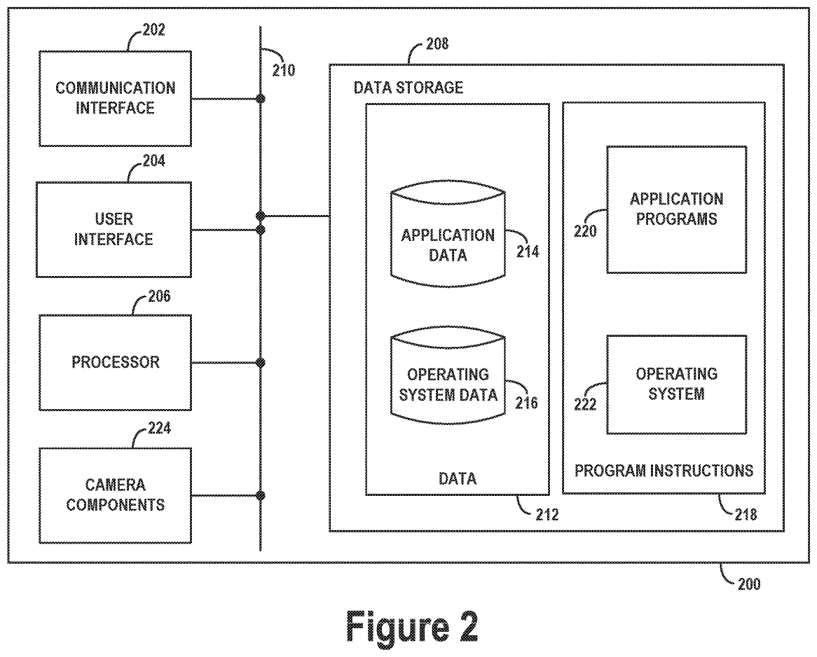

FIG. 2 is a simplified block diagram showing some of the components of an example computing system 200. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a view finder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, application-specific integrated circuits (ASICs), and/or tensor processing units (TPUs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

### II. EXAMPLE CORRESPONDENCE SYSTEM

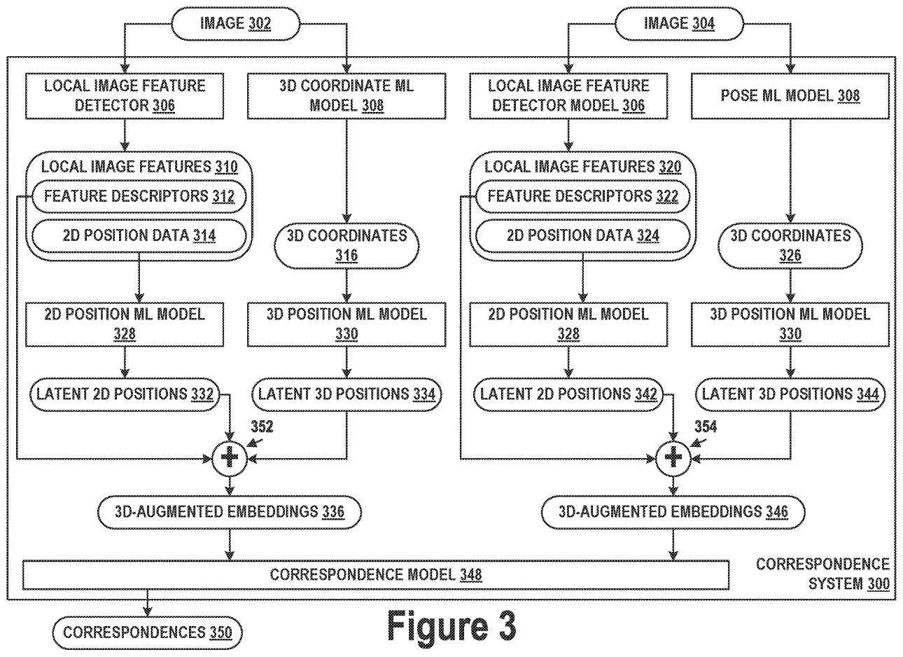

FIG. 3 illustrates correspondence system 300 that may be used to determine correspondences 350 between local image features within image 302 and image 304. Correspondence system 300 may include local image feature detector 306, 3D coordinate ML model 308, 2D position ML model 328, 3D position ML model 330, adder 352, adder 354, and correspondence model 348. Two instances are shown of each of local image feature detector 306, 3D coordinate ML model 308, 2D position ML model 328, and 3D position ML model 330 to indicate that each of these model is applied with respect to both image 302 and image 304. In practice, a single instance of each of these models may be provided as part of correspondence system 300, and may be separately applied with respect to each of image 302 and image 304.

Each of images 302 and 304 may include a corresponding plurality of pixels. Image 302 may depict an object in a first pose (i.e., a first position and/or a first orientation) relative to a camera that captured image 302. Image 304 may depict the object in a second pose (i.e., a second position and/or a second orientation) relative to a camera that captured image 304. The same camera or different cameras may be used to capture images 302 and 304.

Local image feature detector 306 may be configured to generate local image features 310 based on image 302, and local image features 320 based on image 304. Local image features 310 may include feature descriptors 312 and 2D position data 314. Local image features 320 may include feature descriptors 322 and 2D position data 324. 2D position data 314 and 324 may provide information about the locations of local image features 310 and 320, respectively, within images 302 and 304, respectively. Feature descriptors 312 and 322 may provide a latent representation of pixel regions in images 302 and 304, respectively, associated with local image features 310 and 320, respectively.

A corresponding 2D position data of the ith local image feature of local image features 310 may be expressed as pᵢ=(x,y,c)ᵢ, where xᵢ represents the horizontal (e.g., x-axis) coordinate of the ith local image feature within image 302, yᵢ represents the vertical (e.g., y-axis) coordinate of the ith local image feature within image 302, and cᵢ represents a confidence of a detection of the ith local image feature within image 302. A corresponding 2D position data of the jth local image feature of local image features 320 may be expressed as pⱼ=(x,y,c)ⱼ, where xⱼ represents the horizontal coordinate of the jth local image feature within image 304, yⱼ represents the vertical coordinate of the jth local image feature within image 304, and cⱼ represents a confidence of a detection of the jth local image feature within image 302. In some implementations, the confidence values cᵢ and/or cⱼ may be omitted from the 2D position data.

A corresponding feature descriptor of the ith local image feature of local image features 310 may be expressed as dᵢ∈ [symbol] ^{D}, where dᵢ represents the visual content associated with (e.g., located within a predetermined pixel area around) the ith local image feature within image 302. A corresponding feature descriptor of the jth local image feature of local image features 320 may be expressed as dᵢ∈ [symbol] ^{D}, where dᵢ represents the visual content associated with the jth local image feature within image 304.

Local image feature detector 306 may include one or more ML models and/or one or more non-ML-based algorithms. For example, local image feature detector 306 may be implemented using the model architectures, loss functions, and/or training processes discussed in a paper titled “SuperPoint: Self-Supervised Interest Point Detection and Description.” authored by DeTone et al., and published as arXiv: 1712.07629, which is hereby incorporated by reference. Thus, local image feature detector 306 may include a VGG-based encoder, an interest point decoder configured to generate the 2D position data and a descriptor decoder configured to generate the feature descriptors. Alternatively or additionally, local image feature detector 306 may include a scale invariant feature transform (SIFT), a speeded up robust features algorithm (SURF), a Deep Local Feature model (DELF), and/or a Binary Robust Independent Elementary Features algorithm (BRIEF), among other possibilities.

In some implementations, local image features 310 and 320 may be sparsely sampled from images 302 and 304, respectively. Thus, a number of local image features 310 may be less than a threshold fraction (e.g., ½, ¼, ⅛, 1/16, etc.) of a number of pixels of image 302, and a number of local image features 320 may be less than the threshold fraction of a number of pixels of image 304. In other implementations, local image features 310 and 320 may be densely sampled from images 302 and 304, respectively. Thus, the number of local image features 310 may be greater than the threshold fraction (or an additional threshold fraction greater than the threshold fraction) of the number of pixels of image 302, and the number of local image features 320 may be greater than the threshold fraction (or the additional threshold fraction) of the number of pixels of image 304.

3D coordinate ML model 308 may be configured to generate 3D coordinates 316 based on image 302, and 3D coordinates 326 based on image 304. 3D coordinates 316 may be represented, for example, as a matrix having a plurality of elements, with each of the elements representing the 3D coordinates of a spatially corresponding part of image 302. Similarly. 3D coordinates 326 may be represented as a matrix having a plurality of elements, with each of the elements representing the 3D coordinates of a spatially corresponding part of image 304. These 3D coordinate matrices may be viewed as 3D coordinate maps. In some implementations, the 3D coordinate maps may have a same resolution as images 302 and 304, respectively, and thus 3D coordinate ML model 308 may be configured to determine a corresponding 3D coordinate for each pixel of images 302 and 304. In other implementations, the 3D coordinate maps may have a smaller resolution than images 302 and 304, respectively, and thus 3D coordinate ML model 308 may be configured to determine a corresponding 3D coordinate for each group of two or more pixels of images 302 and 304.

Corresponding 3D coordinates of the ith local image feature of local image features 310 may be expressed as nᵢ∈ [symbol] ³, where nᵢ represents the position of the ith local image feature relative to a reference frame associated with the object. Corresponding 3D coordinates of the jth local image feature of local image features 320 may be expressed as nⱼ∈ [symbol] ³, where nⱼ represents the position of the jth local image feature relative to the reference frame associated with the object.

The reference frame may include and/or form a normalized object coordinate space, which may be represented as a rectangular prism (e.g., cube) of predetermined size. The reference frame may define a canonical coordinate frame, and may be shared by a plurality of different object instances of a given class. Training data for 3D coordinate ML model 308 may represent all training objects in the given class in the same pose relative to the reference frame. For example, when the given class represents automobiles, each training sample may include an automobile oriented such that the driver's side rear tire is closest to an origin of the reference frame than any other tire. Further, all training objects represented by the training data may be scaled to fit within the reference frame (e.g., fit within the cube of unit length, width, and height)

3D coordinate ML model 308 may be implemented using the model architectures, loss functions, and/or training processes discussed in a paper titled “Normalized Object Coordinate Space for Category-Level 6D Object Pose and Size Estimation,” authored by Wang et al., and published as arXiv: 1901.02970, which is hereby incorporated by reference. Thus. 3D coordinate ML model 308 may include a Mask-RCNN-based instance segmentation model coupled to three coordinate heads configured to compute, respectively, the x, y, and z coordinates of 3D coordinates 316 and 326. Alternatively or additionally, 3D coordinate ML model 308 may include a U-Net-based instance segmentation model coupled to one or more feed-forward neural networks configured to generate the x, y, and z coordinates. In some implementations, a segmentation mask generated by the instance segmentation model may be used to crop the corresponding image, and the cropped image (and/or the segmentation mask) may be processed by the subsequent part of 3D coordinate ML model 308 to generate the x, y, and z coordinates.

2D position ML model 328 may be configured to generate latent 2D positions 332 based on 2D position data 314, and latent 2D positions 342 based on 2D positions data 324. For example, 2D position ML model 328 may include a multi-layer perceptron (MLP), and may thus be expressed as MLP_{2D}( ) 2D position ML model 328 may be more generally expressed as PM_{2D}( ), and may represent various machine learning architectures other than an MLP. Accordingly, a corresponding latent 2D position of the ith local image feature of local image features 310 may be expressed as PM_{2D}(pᵢ), and a corresponding latent 2D position of the jth local image feature of local image features 320 may be expressed as PM_{2D} (pⱼ). 2D position ML model 328 may be configured to map 2D position data 314 and 324 to a dimension of feature descriptors 312 and 322 (e.g., D, when dᵢ∈ [symbol] ^{D}).

3D position ML model 330 may be configured to generate latent 3D positions 334 based on 3D coordinates 316, and latent 3D positions 344 based on 3D coordinates 326. For example, 3D position ML model 330 may include an MLP, and may thus be expressed as MLP_{3D}( ). 3D position ML model 330 may be more generally expressed as PM_{3D} ( ), and may represent various machine learning architectures other than an MLP. Accordingly, a corresponding latent 3D position of the ith local image feature of local image features 310 may be expressed as PM_{3D} (nᵢ), and a corresponding latent 3D position of the jth local image feature of local image features 320 may be expressed as PM_{3D} (nⱼ). 3D position ML model 330 may be configured to map 3D coordinates 316 and 326 to the dimension of feature descriptors 312 and 322.

In some implementations, 3D position ML model 330 may be configured to apply a positional encoding that transforms the 3D coordinates into a higher-dimensional space. The position encoding may include a plurality of periodic functions (e.g., sine and cosine functions) of varying frequencies configured to transform a scalar value representing a 3D coordinate into a vector comprising a plurality of values. For example, each scalar value may be represented using a vector having 10 or more values, thus improving the representational capacity of small changes in the scalar value. 3D position ML model 330 may be configured to apply the positional encoding to each of 3D coordinates 316 and 3D coordinates 326 before processing 3D coordinates 316 and 326 by a ML model components. Representing the 3D coordinates using the positional encoding may improve an accuracy of correspondences 350

Adder 352 may be configured to determine 3D augmented embeddings 336 based on a sum of feature descriptors 312, latent 2D positions 332, and latent 3D positions 334. Adder 354 may be configured to determine 3D augmented embeddings 346 based on a sum of feature descriptors 322, latent 2D positions 342, and latent 3D positions 344. Accordingly, corresponding 3D-augmented embedding of the ith local image feature of local image features 310 may be expressed as

$${x}_{i}^{′} = {d}_{i} + {PM}_{2 D} ( {p}_{i} ) + {PM}_{3 D} ( {n}_{i} ) ,$$

and a corresponding 3D-augmented embedding of the jth local image feature of local image features 320 may be expressed as

$${x}_{j}^{′} = {d}_{j} + {PM}_{2 D} ( {p}_{j} ) + {PM}_{3 D} ( {n}_{j} ) .$$

In implementations where 3D position ML model 330 applies a positional encoding, corresponding 3D-augmented embedding of the ith local image feature of local image features 310 may be expressed as \hat{x}ᵢ=dᵢ+PM_{2D} (pᵢ)+PM_{3D} (PE(nᵢ)), and a corresponding 3D-augmented embedding of the jth local image feature of local image features 320 may be expressed as \hat{x}ⱼ=dⱼ+PM_{2D}(pⱼ)+PM_{3D}(PE(nⱼ)). In some implementations, adders 352 and 354 may be replaced by a concatenation operator and/or another operator configured to combine multiple vectors.

Correspondence model 348 may be configured to determine correspondences 350 based on 3D-augmented embeddings 336 and 3D-augmented embeddings 346. Correspondences 350 may indicate, for each respective local image feature of local image features 310, (i) a corresponding local image feature of local image features 320 that represents a same part of the object as the respective local image feature or (ii) that the respective local image feature does not have a counterpart (e.g., is not visible) in local image features 320. Thus, correspondences 350 and 2D position data 314 and 324 of local image features 310 and 320, respectively, may be indicative of a relative pose of the object between images 302 and 304, and may thus be used to facilitate determination of one or more physical and/or geometric properties of the object.

Correspondence model 348 may include (i) a match ML model configured to generate match descriptors based on 3D-augmented embeddings 336 and 346 and/or (ii) a matching algorithm configured to compare 3D-augmented embeddings 336 and 346 and/or the match descriptors thereof to determine a corresponding match score for each candidate pairing (e.g., each possible combination) of local image features 310 and 320. Correspondence model 348 may be configured to select, for each respective local image feature of local image features 310, the corresponding local image feature of local image features 320 based on the corresponding match score of this candidate pairing. For example, a first local image feature of local image features 310 may be mapped to a second local image feature of local image features 320 based on the match score of these two features being higher than other match scores associated with the first local image feature.

In some implementations, correspondence model 348 may include a graph neural network configured to facilitate determination of correspondences 350. The GNN may be configured to determine a first plurality of self-attention scores representing an attention between 3D-augmented embeddings 336, a second plurality of self-attention scores representing an attention between 3D-augmented embeddings 346, and a plurality of cross-attention scores representing an attention between 3D-augmented embeddings 336 and 3D-augmented embeddings 346. The determination of the self-attention scores may allow for sharing of information between local image features within the same image, while the determination of the cross-attention scores may allow for sharing of information between local image features across different images.

The GNN may be configured to generate a match descriptor for each 3D-augmented embedding of 3D-augmented embeddings 336 and 346 based on the self-attention and cross-attention scores. Thus, the match descriptor of a given local image feature may represent both (i) the properties of the given local image feature and (ii) relationships between the properties of the local image feature and all other local image features identified in images 302 and 304. That is, the match descriptor of the given local image feature may account for the context in which the given local image is present.

Correspondence model 348 may be implemented using the model architectures, loss functions, and/or training processes discussed in a paper titled “SuperGlue: Learning Feature Matching with Graph Neural Networks,” authored by Sarlin et al., and published as arXiv: 1911.11763, which is hereby incorporated by reference. Thus, correspondence model 348 may include an attention GNN and a matching layer that includes an inner product-based similarity calculator, dustbins to handle unmatched local image features, and an implementation of the Sinkhorn algorithm.

### III. EXAMPLE CORRESPONDENCE IMAGES

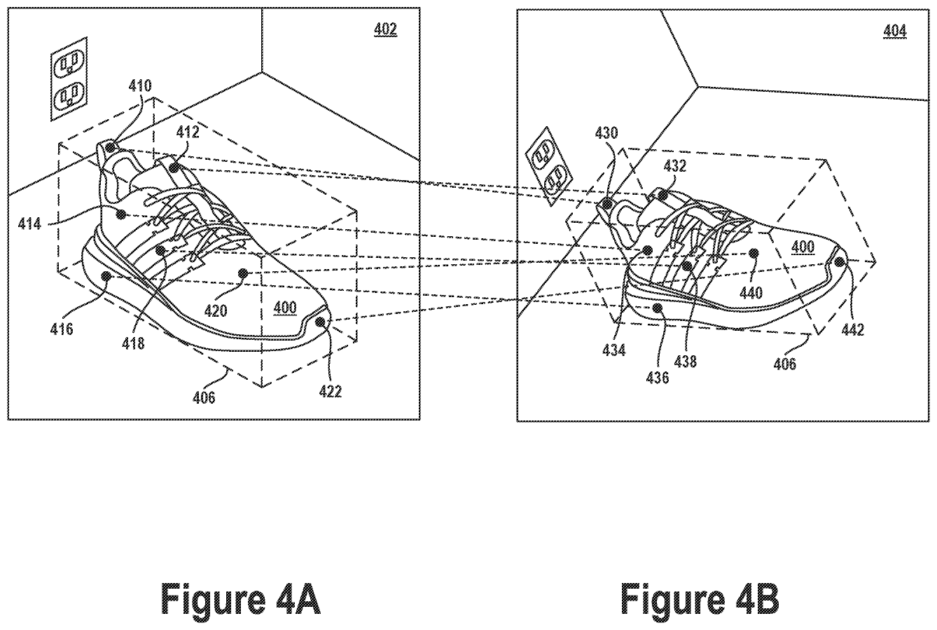

FIG. 4A illustrates image 402 of shoe 400 in a first pose relative to a camera that captured image 402. FIG. 4B illustrates image 404 of shoe 400 in a second pose relative to a camera that captured image 404. The first pose of shoe 400 in image 402 is different from the second pose of shoes 400 in image 404.

Reference frame 406 of shoe 400 is shown in each of images 402 and 404 as a rectangular prism that surrounds shoe 400. The 3D coordinates determined by 3D coordinate ML model 308 based on images 402 and/or 404 may be expressed relative to reference frame 406. Each of a length, width, and height of reference frame 406 may be normalized to a corresponding predetermined value. For example, reference frame 406 may represent a cube with unit length, width, and height, with shoe instances being scaled to fit within reference frame 406.

Image 402 includes visual representations of local image features 410, 412, 414, 416, 418, 420, and 422 (i.e., local image features 410-422). Image 404 includes visual representations of local image features 430, 432, 434, 436, 438, 440, and 442 (i.e., local image features 430-442).

The 2D position data of local image features 410-422 may include the pixel coordinates of local image features 410-422 within image 402, and the 2D position data of local image features 430-442 may include the pixel coordinates of local image features 430-442 within image 404. For example, the 2D position data of local image feature 414 may include the pixel coordinates of local image feature 414 within image 402.

The feature descriptors of local image features 410-422 may include respective latent representations of respective visual contents of respective pluralities of pixels associated with (e.g., surrounding) local image features 410-422 within image 402, and the feature descriptors of local image features 430-442 may include respective latent representation of respective visual contents of respective pluralities of pixels associated with local image features 430-442 within image 404. For example, the feature descriptor of local image feature 418 may include a latent representation of the visual contents of a 10 pixel by 10 pixel region centered on local image feature 418 within image 402.

The 3D coordinates of local image features 410-422 may include (x, y, z) coordinates representing positions of local image features 410-422 relative to reference frame 406, and the 3D coordinates of local image features 430-442 may include (x, y, z) coordinates representing positions of local image features 430-442 relative to reference frame 406. For example, the 3D coordinates of local image feature 420 may include (x, y, z) coordinates representing a position of local image feature 420 relative to reference frame 406.

A correspondence between local image features 410-422 and local image features 430-442 is shown using corresponding dashed lines therebetween. Specifically, local image feature 410 is mapped to (i.e., corresponds to, and thus represents the same part of shoe 400 as) local image feature 430, local image feature 412 is mapped to local image feature 432, local image feature 414 is mapped to local image feature 434, local image feature 416 is mapped to local image feature 436, local image feature 418 is mapped to local image feature 438, local image feature 420 is mapped to local image feature 440, and local image feature 422 is mapped to local image feature 442.

The correspondence between local image features 410-422 and local image features 430-442 may be used to determine one or more geometric properties associated with shoe 400. In one example, the correspondence may be used to determine a pose of the camera when capturing image 404 relative to a pose of the camera when capturing image 402. Such relative camera poses between different image pairs, and the images themselves, may be used to generate a 3D model of shoe 400 and/or generate a new view of shoe 400 from a perspective that is not represented by any of the images. For example, based on a plurality of images of shoe 400, an ML model may be trained to generate novel views of shoe 400 from unseen viewpoints. In another example, image 402 may be associated with a geographic location, and the correspondence between images 402 and 404 may thus localize image 404 relative to the geographic location of image 402.

### IV. EXAMPLE TRAINING SYSTEM

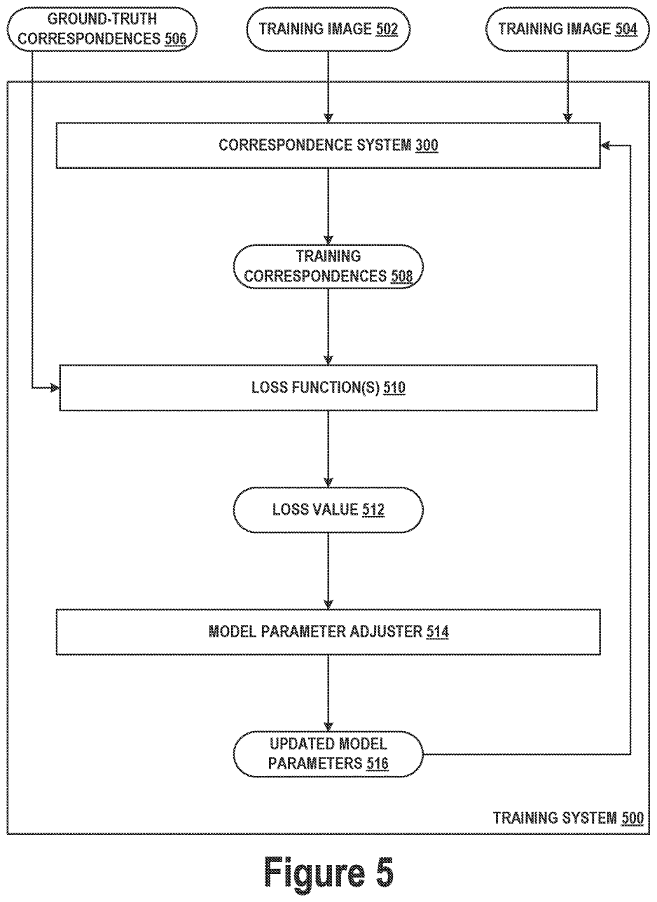

FIG. 5 illustrates training system 500 configured to train one or more trainable components of correspondence system 300 based on training image 502, training image 504, and ground-truth correspondences 506. Training system 500 may include loss function(s) 510 and model parameter adjuster 514.

Correspondence system 300 may be configured to generate training correspondences 508 based on training image 502 and training image 504. Training image 502 may represent a training object in a third pose and training image 504 may represent the training object in a fourth pose that is different from the third pose. Accordingly, training image 502 may be analogous to images 302 and 402, and training image 504 may be analogous to images 304 and 404, but may be processed at training time rather than at inference time. Training correspondences 508 may be analogous to correspondences 350, but may be generated at training time rather than at inference time.

Loss function(s) 510 may be configured to generate loss value 512 based at least on training correspondences 508 and ground-truth correspondences 506. For example, loss function(s) 510 may include a negative log-likelihood loss function. Specifically, loss function(s) 510 may determine a negative log of (i) match scores associated with correctly matched pairs of local image feature and (ii) match scores associated with correctly unmatched local image features (e.g., image features detected and/or visible in only one training image, but not the other). Thus, loss function(s) 510 may be configured to incentivize correspondence system 300 to generate training correspondences 508 that match ground-truth correspondences 506.

In some implementations, loss function 510 may additionally or alternatively include other model-specific loss terms, as described in the above-cited publications, that may be used for training of specific components of correspondence system 300. For example, loss function 510 may include a detection loss function for training local image feature detector 306 and/or a 3D coordinate loss function for training 3D coordinate ML model 308. These loss functions may be used for pretraining one or more components of correspondence system 300, and/or for joint training of an entirety of correspondence system 300.

Model parameter adjuster 514 may be configured to determine updated model parameters 516 based on loss value 512. Specifically, updated model parameters 516 may be selected such that, during a subsequent iteration of processing of training images 502 and 504, training correspondences 508 more closely match ground-truth correspondences 506. Updated model parameters 516 may include one or more updated parameters of any trainable component of correspondence system 300, including local image feature detector 306, 3D coordinate ML model 308, 2D position ML model 328, 3D position ML model 330, and/or correspondence model 348.

Model parameter adjuster 514 may be configured to determine updated model parameters 516 by, for example, determining a gradient of loss function 510. Based on this gradient and loss value 512, model parameter adjuster 514 may be configured to select updated model parameters 516 that are expected to reduce loss value 512, and thus improve a performance of correspondence system 300. After applying updated model parameters 516 to correspondence system 300, the operations discussed above may be repeated to compute another instance of loss value 512 and, based thereon, another instance of updated model parameters 516 may be determined and applied to correspondence system to further improve the performance thereof. Such training of correspondence system 300 may be repeated until, for example, loss value 512 is reduced to below a target loss value.

In some implementations, the training object depicted in training images 502 and 504 may belong to as same class of objects as the object expected to be depicted in images processed at inference time. Thus, at least one component of correspondence system 300 (e.g., 3D coordinate ML model 308) may be object class specific. For example, the class of objects may be shoes, and correspondence system 300 may thus be trained to operate with respect to images of different instances of shoes. In other implementations, all components of correspondence system 300 may be independent of the object class, and correspondence system may thus be trained and subsequently used to process images of different types of objects (e.g., shoes and cars).

### V. ADDITIONAL EXAMPLE OPERATIONS

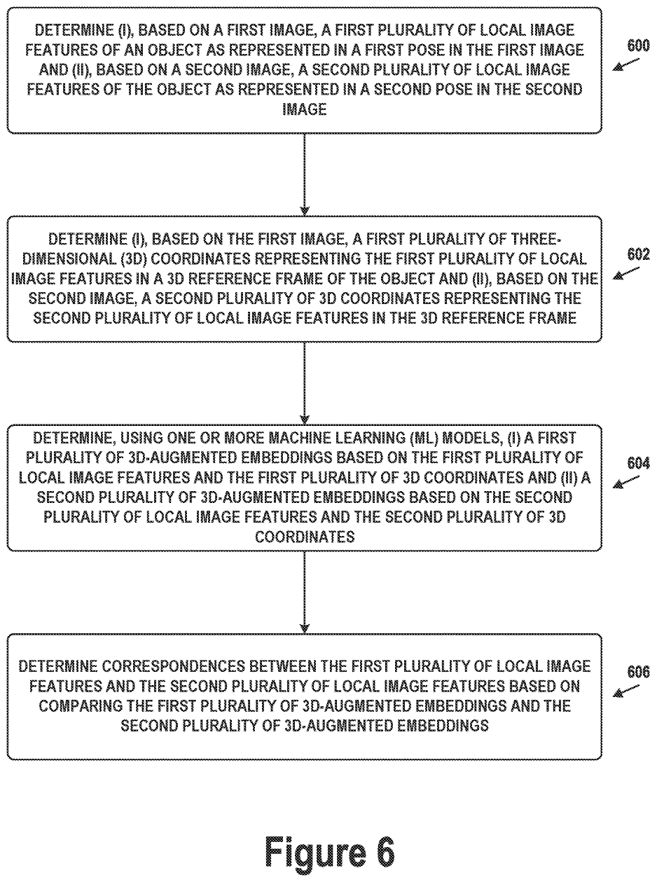

FIG. 6 illustrates a flow chart of operations related to determining correspondences between image features of an object represented in different poses in at least two different images. The operations may be carried out by computing device 100, computing system 200, correspondence system 300, and/or training system 500, among other possibilities. The embodiments of FIG. 6 may be simplified by the removal of any one or more of the features shown therein. Further, these embodiments may be combined with features, aspects, and/or implementations of any of the previous figures or otherwise described herein.

Block 600 may involve determining (i), based on a first image, a first plurality of local image features of an object as represented in a first pose in the first image and (ii), based on a second image, a second plurality of local image features of the object as represented in a second pose in the second image.

Block 602 may involve determining (i), based on the first image, a first plurality of three-dimensional (3D) coordinates representing the first plurality of local image features in a 3D reference frame of the object and (ii), based on the second image, a second plurality of 3D coordinates representing the second plurality of local image features in the 3D reference frame.

Block 604 may involve determining, using one or more ML models. (i) a first plurality of 3D-augmented embeddings based on the first plurality of local image features and the first plurality of 3D coordinates and (ii) a second plurality of 3D-augmented embeddings based on the second plurality of local image features and the second plurality of 3D coordinates.

Block 606 may involve determining correspondences between the first plurality of local image features and the second plurality of local image features based on comparing the first plurality of 3D-augmented embeddings and the second plurality of 3D-augmented embeddings.

In some embodiments, the one or more ML models may include a 3D position ML model configured to generate latent 3D positions based on 3D coordinates. Determining the first plurality of 3D-augmented embeddings may include, for each respective local image feature of the first plurality of local image features, determining a corresponding latent 3D position by processing, by the 3D position ML model, a respective 3D coordinate of the first plurality of 3D coordinates. The respective 3D coordinate may correspond to the respective local image feature. A corresponding 3D-augmented embedding may be determined for the respective local image feature based on (i) the respective local image feature and (ii) the corresponding latent 3D position. Determining the second plurality of 3D-augmented embeddings may include, for each respective local image feature of the second plurality of local image features, determining a corresponding latent 3D position by processing, by the 3D position ML model, a corresponding 3D coordinate of the second plurality of 3D coordinates. The respective 3D coordinate may correspond to the respective local image feature. A corresponding 3D-augmented embedding may be determined for the respective local image feature based on (i) the respective local image feature and (ii) the corresponding latent 3D position.

In some embodiments, determining the corresponding latent 3D position for each respective local image feature of the first plurality of local image features may include determining a corresponding positional encoding of the respective 3D coordinate of the first plurality of 3D coordinates. A number of values representing the corresponding positional encoding may be greater than a number of values representing the respective 3D coordinate. The corresponding positional encoding may be processed by the 3D position ML model. Determining the corresponding latent 3D position for each respective local image feature of the second plurality of local image features may include determining a corresponding positional encoding of the respective 3D coordinate of the second plurality of 3D coordinates. A number of values representing the corresponding positional encoding may be greater than a number of values representing the respective 3D coordinate. The corresponding positional encoding may be processed by the 3D position ML model.

In some embodiments, determining the corresponding 3D-augmented embedding of the first plurality of 3D-augmented embeddings may include determining a corresponding first sum based on (i) the respective local image feature and (ii) the corresponding latent 3D position. Determining the corresponding 3D-augmented embedding of the second plurality of 3D-augmented embeddings may include determining a corresponding second sum based on (i) the respective local image feature and (ii) the corresponding latent 3D position.

In some embodiments, one or more of the first plurality of local image features, the second plurality of local image features, the first plurality of 3D coordinates, the second plurality of 3D coordinates, or the correspondences may be determined using one or more additional ML models. The one or more additional ML models may be pretrained independently of the 3D position ML model. After the one or more additional ML models are pretrained, the 3D position ML model may be trained jointly with at least one of the one or more additional ML models.

In some embodiments, the one or more ML models may include an artificial neural network.

In some embodiments, determining the first plurality of 3D coordinates may include determining, based on the first image, a first segmentation mask corresponding to the object as represented in the first pose in the first image, and determining the first plurality of 3D coordinates based on the first segmentation mask and pixels of the first image that correspond to the first segmentation mask. Determining the second plurality of 3D coordinates may include determining, based on the second image, a second segmentation mask corresponding to the object as represented in the second pose in the second image, and determining the second plurality of 3D coordinates based on the second segmentation mask and pixels of the second image that correspond to the second segmentation mask

In some embodiments, the 3D reference frame may include a normalized object coordinate space represented by a cube of predetermined size.

In some embodiments, determining the first plurality of 3D coordinates may include determining, based on processing the first image by a 3D coordinate ML model, a first 3D coordinate map that indicates, for each respective pixel of the first image that contains a corresponding local image feature of the first plurality of local image features, corresponding 3D coordinates in the 3D reference frame. Determining the second plurality of 3D coordinates may include determining, based on processing the second image by the 3D coordinate ML model, a second 3D coordinate map that indicates, for each respective pixel of the second image that contains a corresponding local image feature of the second plurality of local image features, corresponding 3D coordinates in the 3D reference frame.

In some embodiments, each respective local image feature of the first plurality of local image features may include: (i) a corresponding feature position data that represents a two-dimensional (2D) position of the respective local image feature within the first image and a confidence value associated with detection of the respective local image feature within the first image and (ii) a corresponding feature descriptor that provides a latent representation of a visual content associated with the respective local image feature. Each respective local image feature of the second plurality of local image features may include: (i) a corresponding feature position data that represents a 2D position of the respective local image feature within the second image and a confidence value associated with detection of the respective local image feature within the second image and (ii) a corresponding feature descriptor that provides a latent representation of a visual content associated with the respective local image feature.

In some embodiments, the one or more ML models may include a 2D position ML model configured to generate latent 2D positions based on 2D positions of local image features. Determining the first plurality of 3D-augmented embeddings may include, for each respective local image feature of the first plurality of local image features: determining a corresponding latent 2D position by processing, by the 2D position ML model, the corresponding 2D position of the respective local image feature within the first image, and determining a corresponding third sum based on (i) the corresponding feature descriptor and (ii) the corresponding latent 2D position. Determining the second plurality of 3D-augmented embeddings may include, for each respective local image feature of the second plurality of local image features: determining a corresponding latent 2D position by processing, by the 2D position ML model, the corresponding 2D position of the respective local image feature within the second image, and determining a corresponding fourth sum based on (i) the corresponding feature descriptor and (ii) the corresponding latent 2D position.

In some embodiments, determining the correspondences between the first plurality of local image features and the second plurality of local image features may include determining, by a graph neural network (GNN), a first plurality of self-attention scores among the first plurality of 3D-augmented embeddings, and determining, by the GNN, a second plurality of self-attention scores among the second plurality of 3D-augmented embeddings. Determining the correspondences may also include determining, by the GNN, a plurality of cross-attention scores between the first plurality of 3D-augmented embeddings and the second plurality of 3D-augmented embeddings, and determining, by the GNN and for each respective local image feature of the first plurality of local image features and the second plurality of local image features, a corresponding match descriptor. The correspondences between the first plurality of local image features and the second plurality of local image features may be determined based on the corresponding match descriptor of each respective local image feature of the first plurality of local image features and the second plurality of local image features.

In some embodiments, determining the correspondences between the first plurality of local image features and the second plurality of local image features may include determining a plurality of similarity scores by comparing, for each respective local image feature of the first plurality of local image features, the respective local image feature to each of the second plurality of local image features. Determining the correspondences may also include selecting, based on the plurality of similarity scores and for each respective local image feature of at least a subset of the first plurality of local image features, a corresponding local image feature of the second plurality of local image features.

In some embodiments, the first plurality of local image features may be sparsely sampled from the first image such that a number of the first plurality of local image features is less than a threshold fraction of a number of pixels of the first image. The second plurality of local image features may be sparsely sampled from the second image such that a number of the second plurality of local image features is less than the threshold fraction of a number of pixels of the second image.

In some embodiments, a 3D representation of the object may be generated based on the correspondences.

In some embodiments, a third image representing the object in a third pose that is different from the first pose and the second pose may be generated based on the correspondences.

In some embodiments, a location within an environment represented by the first image and the second image and containing the object may be determined based on the correspondences.

In some embodiments, a training sample may be obtained. The training sample may include (i) a first training image representing a training object in a first training pose, (ii) a second training image representing the training object in a second training pose, and (iii) a ground-truth correspondence between a first plurality of training local image features of the object as represented in the first training pose and a second plurality of training local image features of the object as represented in the second training pose. A third plurality of training local image features of the training object as represented in the first training pose in the first training image may be determined based on the first training image. A fourth plurality of training local image features of the training object as represented in the second training pose in the second training image may be determined based on the second training image. A first plurality of training 3D coordinates representing the third plurality of training local image features in the 3D reference frame may be determined based on the first training image. A second plurality of training 3D coordinates representing the fourth plurality of training local image features in the 3D reference frame may be determined based on the second training image. A first plurality of training 3D-augmented embeddings may be determined using the one or more ML models and based on the third plurality of training local image features and the first plurality of training 3D coordinates. A second plurality of training 3D-augmented embeddings may be determined using the one or more ML models and based on the fourth plurality of training local image features and the second plurality of training 3D coordinates. Training correspondences may be determined between the third plurality of training local image features and the fourth plurality of training local image features based on comparing the first plurality of training 3D-augmented embeddings and the second plurality of training 3D-augmented embeddings. A loss value may be determined based on the training correspondences and the ground-truth correspondences. One or more parameters of the one or more ML models may be updated based on the loss value.

In some embodiments, the object and the training object may belong to a same object class.

### VI. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A computer-implemented method comprising:
determining (i), based on a first image, a first plurality of local image features of an object as represented in a first pose in the first image and (ii), based on a second image, a second plurality of local image features of the object as represented in a second pose in the second image;
determining (i), based on the first image, a first plurality of three-dimensional (3D) coordinates representing the first plurality of local image features in a 3D reference frame of the object and (ii), based on the second image, a second plurality of 3D coordinates representing the second plurality of local image features in the 3D reference frame;
determining, using one or more machine learning (ML) models, (i) a first plurality of 3D-augmented embeddings based on the first plurality of local image features and the first plurality of 3D coordinates and (ii) a second plurality of 3D-augmented embeddings based on the second plurality of local image features and the second plurality of 3D coordinates; and
determining correspondences between the first plurality of local image features and the second plurality of local image features based on comparing the first plurality of 3D-augmented embeddings and the second plurality of 3D-augmented embeddings.

2. The computer-implemented method of claim 1, wherein:
the one or more ML models comprise a 3D position ML model configured to generate latent 3D positions based on 3D coordinates;
determining the first plurality of 3D-augmented embeddings comprises, for each respective local image feature of the first plurality of local image features:
determining a corresponding latent 3D position by processing, by the 3D position ML model, a respective 3D coordinate of the first plurality of 3D coordinates, wherein the respective 3D coordinate corresponds to the respective local image feature; and
determining a corresponding 3D-augmented embedding based on (i) the respective local image feature and (ii) the corresponding latent 3D position; and
determining the second plurality of 3D-augmented embeddings comprises, for each respective local image feature of the second plurality of local image features:
determining a corresponding latent 3D position by processing, by the 3D position ML model, a corresponding 3D coordinate of the second plurality of 3D coordinates, wherein the respective 3D coordinate corresponds to the respective local image feature; and
determining a corresponding 3D-augmented embedding based on (i) the respective local image feature and (ii) the corresponding latent 3D position.

3. The computer-implemented method of claim 2, wherein:
determining the corresponding latent 3D position for each respective local image feature of the first plurality of local image features comprises:
determining a corresponding positional encoding of the respective 3D coordinate of the first plurality of 3D coordinates, wherein a number of values representing the corresponding positional encoding is greater than a number of values representing the respective 3D coordinate; and
processing, by the 3D position ML model, the corresponding positional encoding; and
determining the corresponding latent 3D position for each respective local image feature of the second plurality of local image features comprises:
determining a corresponding positional encoding of the respective 3D coordinate of the second plurality of 3D coordinates, wherein a number of values representing the corresponding positional encoding is greater than a number of values representing the respective 3D coordinate; and
processing, by the 3D position ML model, the corresponding positional encoding.

4. The computer-implemented method of claim 2, wherein:
determining the corresponding 3D-augmented embedding of the first plurality of 3D-augmented embeddings comprises:
determining a corresponding first sum based on (i) the respective local image feature and (ii) the corresponding latent 3D position; and
determining the corresponding 3D-augmented embedding of the second plurality of 3D-augmented embeddings comprises:
determining a corresponding second sum based on (i) the respective local image feature and (ii) the corresponding latent 3D position.

5. The computer-implemented method of claim 2, wherein one or more of the first plurality of local image features, the second plurality of local image features, the first plurality of 3D coordinates, the second plurality of 3D coordinates, or the correspondences are determined using one or more additional ML models, wherein the one or more additional ML models are pretrained independently of the 3D position ML model, and wherein, after the one or more additional ML models are pretrained, the 3D position ML model is trained jointly with at least one of the one or more additional ML models.

6. The computer-implemented method of claim 1, wherein the one or more ML models comprise an artificial neural network.

7. The computer-implemented method of claim 1, wherein:
determining the first plurality of 3D coordinates comprises:
determining, based on the first image, a first segmentation mask corresponding to the object as represented in the first pose in the first image; and
determining the first plurality of 3D coordinates based on the first segmentation mask and pixels of the first image that correspond to the first segmentation mask; and
determining the second plurality of 3D coordinates comprises:
determining, based on the second image, a second segmentation mask corresponding to the object as represented in the second pose in the second image; and
determining the second plurality of 3D coordinates based on the second segmentation mask and pixels of the second image that correspond to the second segmentation mask.

8. The computer-implemented method of claim 1, wherein the 3D reference frame comprises a normalized object coordinate space represented by a cube of predetermined size.

9. The computer-implemented method of claim 1, wherein:
determining the first plurality of 3D coordinates comprises:
determining, based on processing the first image by a 3D coordinate ML model, a first 3D coordinate map that indicates, for each respective pixel of the first image that contains a corresponding local image feature of the first plurality of local image features, corresponding 3D coordinates in the 3D reference frame;
determining the second plurality of 3D coordinates comprises:
determining, based on processing the second image by the 3D coordinate ML model, a second 3D coordinate map that indicates, for each respective pixel of the second image that contains a corresponding local image feature of the second plurality of local image features, corresponding 3D coordinates in the 3D reference frame.

10. The computer-implemented method of claim 1, wherein each respective local image feature of the first plurality of local image features comprises: (i) a corresponding feature position data that represents a two-dimensional (2D) position of the respective local image feature within the first image and a confidence value associated with detection of the respective local image feature within the first image and (ii) a corresponding feature descriptor that provides a latent representation of a visual content associated with the respective local image feature, and wherein each respective local image feature of the second plurality of local image features comprises: (i) a corresponding feature position data that represents a 2D position of the respective local image feature within the second image and a confidence value associated with detection of the respective local image feature within the second image and (ii) a corresponding feature descriptor that provides a latent representation of a visual content associated with the respective local image feature.

11. The computer-implemented method of claim 10, wherein:
the one or more ML models comprise a 2D position ML model configured to generate latent 2D positions based on 2D positions of local image features;
determining the first plurality of 3D-augmented embeddings comprises, for each respective local image feature of the first plurality of local image features:
determining a corresponding latent 2D position by processing, by the 2D position ML model, the corresponding 2D position of the respective local image feature within the first image; and
determining a corresponding third sum based on (i) the corresponding feature descriptor and (ii) the corresponding latent 2D position; and
determining the second plurality of 3D-augmented embeddings comprises, for each respective local image feature of the second plurality of local image features:
determining a corresponding latent 2D position by processing, by the 2D position ML model, the corresponding 2D position of the respective local image feature within the second image; and
determining a corresponding fourth sum based on (i) the corresponding feature descriptor and (ii) the corresponding latent 2D position.

12. The computer-implemented method of claim 1, wherein determining the correspondences between the first plurality of local image features and the second plurality of local image features comprises:
determining, by a graph neural network (GNN), a first plurality of self-attention scores among the first plurality of 3D-augmented embeddings;
determining, by the GNN, a second plurality of self-attention scores among the second plurality of 3D-augmented embeddings;
determining, by the GNN, a plurality of cross-attention scores between the first plurality of 3D-augmented embeddings and the second plurality of 3D-augmented embeddings;
determining, by the GNN and for each respective local image feature of the first plurality of local image features and the second plurality of local image features, a corresponding match descriptor; and
determining the correspondences between the first plurality of local image features and the second plurality of local image features based on the corresponding match descriptor of each respective local image feature of the first plurality of local image features and the second plurality of local image features.

13. The computer-implemented method of claim 12, wherein determining the correspondences between the first plurality of local image features and the second plurality of local image features comprises:
determining a plurality of similarity scores by comparing, for each respective local image feature of the first plurality of local image features, the respective local image feature to each of the second plurality of local image features; and
selecting, based on the plurality of similarity scores and for each respective local image feature of at least a subset of the first plurality of local image features, a corresponding local image feature of the second plurality of local image features.

14. The computer-implemented method of claim 1, wherein the first plurality of local image features are sparsely sampled from the first image such that a number of the first plurality of local image features is less than a threshold fraction of a number of pixels of the first image, and wherein the second plurality of local image features are sparsely sampled from the second image such that a number of the second plurality of local image features is less than the threshold fraction of a number of pixels of the second image.

15. The computer-implemented method of claim 1, further comprising:
generating, based on the correspondences, a 3D representation of the object; or
generating, based on the correspondences, a third image representing the object in a third pose that is different from the first pose and the second pose.

16. The computer-implemented method of claim 1, further comprising:
determining, based on the correspondences, a location within an environment represented by the first image and the second image and containing the object.

17. The computer-implemented method of claim 1, further comprising:
obtaining a training sample comprising (i) a first training image representing a training object in a first training pose, (ii) a second training image representing the training object in a second training pose, and (iii) a ground-truth correspondence between a first plurality of training local image features of the object as represented in the first training pose and a second plurality of training local image features of the object as represented in the second training pose;
determining (i), based on the first training image, a third plurality of training local image features of the training object as represented in the first training pose in the first training image and (ii), based on the second training image, a fourth plurality of training local image features of the training object as represented in the second training pose in the second training image;
determining (i), based on the first training image, a first plurality of training 3D coordinates representing the third plurality of training local image features in the 3D reference frame and (ii), based on the second training image, a second plurality of training 3D coordinates representing the fourth plurality of training local image features in the 3D reference frame;
determining, using the one or more ML models, (i) a first plurality of training 3D-augmented embeddings based on the third plurality of training local image features and the first plurality of training 3D coordinates and (ii) a second plurality of training 3D-augmented embeddings based on the fourth plurality of training local image features and the second plurality of training 3D coordinates; and
determining training correspondences between the third plurality of training local image features and the fourth plurality of training local image features based on comparing the first plurality of training 3D-augmented embeddings and the second plurality of training 3D-augmented embeddings;
determining a loss value based on the training correspondences and the ground-truth correspondence; and
updating one or more parameters of the one or more ML models based on the loss value.

18. The computer-implemented method of claim 17, wherein the object and the training object belong to a same object class.

19. A system comprising:
a processor; and
a non-transitory computer-readable medium having stored thereon instructions that, when executed by the processor, cause the processor to perform operations comprising:
determining (i), based on a first image, a first plurality of local image features of an object as represented in a first pose in the first image and (ii), based on a second image, a second plurality of local image features of the object as represented in a second pose in the second image;
determining (i), based on the first image, a first plurality of three-dimensional (3D) coordinates representing the first plurality of local image features in a 3D reference frame of the object and (ii), based on the second image, a second plurality of 3D coordinates representing the second plurality of local image features in the 3D reference frame;
determining, using one or more machine learning (ML) models, (i) a first plurality of 3D-augmented embeddings based on the first plurality of local image features and the first plurality of 3D coordinates and (ii) a second plurality of 3D-augmented embeddings based on the second plurality of local image features and the second plurality of 3D coordinates; and
determining correspondences between the first plurality of local image features and the second plurality of local image features based on comparing the first plurality of 3D-augmented embeddings and the second plurality of 3D-augmented embeddings.

20. A non-transitory computer-readable medium having stored thereon instructions that, when executed by a computing device, cause the computing device to perform operations comprising:
determining (i), based on a first image, a first plurality of local image features of an object as represented in a first pose in the first image and (ii), based on a second image, a second plurality of local image features of the object as represented in a second pose in the second image;
determining (i), based on the first image, a first plurality of three-dimensional (3D) coordinates representing the first plurality of local image features in a 3D reference frame of the object and (ii), based on the second image, a second plurality of 3D coordinates representing the second plurality of local image features in the 3D reference frame;
determining, using one or more machine learning (ML) models, (i) a first plurality of 3D-augmented embeddings based on the first plurality of local image features and the first plurality of 3D coordinates and (ii) a second plurality of 3D-augmented embeddings based on the second plurality of local image features and the second plurality of 3D coordinates; and
determining correspondences between the first plurality of local image features and the second plurality of local image features based on comparing the first plurality of 3D-augmented embeddings and the second plurality of 3D-augmented embeddings.
